(19) United States
(12) Patent Application Publication
(10) Pub. No.: US 2026/0045900 A1
(43) Pub. Date: Feb. 12, 2026

(54) SOLAR INSTALLATION

(71) Applicant: DHP TECHNOLOGY AG, Zizers (CH)

(72) Inventors: Gian Andri DIEM, Zizers (CH); Peter KASPER, Zizers (CH)

(21) Appl. No.: 19/102,461

(22) PCT Filed: Aug. 11, 2023
(86) PCT No.: PCT/CH2023/050027

§ 371 Date: Feb. 10, 2025

(30) Foreign Application Priority Data
Aug. 12, 2022 (CH) CH000952/2022

(51) Int. Cl. H02S 20/21; H02S 30/20

(52) U.S. Cl. CPC H02S 20/21; H02S 30/20

(57) ABSTRACT

A solar energy system with a plurality of solar panels arranged in a row, wherein there is an innermost and an outermost solar panel, and at least one holding element oriented in the longitudinal direction of the solar energy system, on which the solar panels are held one behind the other and along which the solar panels can be moved by an engagement means from an extended operating position into a retracted protective position and vice versa, wherein adjacent solar panels are connected to one another in an articulated manner, so that a pushing or pulling force can be transmitted from one solar panel to an adjacent solar panel. The outermost and innermost solar panels are pressed against each other in the protective position by a mechanical force, forming a stable package of solar panels that enables the solar panels to protect themselves from the weather.

### FIELD OF THE INVENTION

The invention relates to a solar energy system (solar installation) as defined in the preamble to claim 1 and a use of the solar energy system as defined in claim 14.

### PRIOR ART

From the state of the art in solar energy system technology, solar panels are known that can be moved back and forth between an extended operating position and a retracted protective position along a cable system. EP 2 669 594 B1 discloses an enclosure in which the solar panels are housed in their protective position. A cover plate is attached to the outermost solar panel. If the solar panels are retracted through an opening in the enclosure, the cover plate will inevitably close this opening when the solar panels are in the protective position.

However, the enclosure takes up space or area at the solar energy system that cannot be used by the solar panels to generate electricity. In addition, the provision of the enclosure is cost-intensive and accordingly increases the investment costs of the solar energy system. The enclosure also inevitably leads to shadow casting and obstructed visibility. This is particularly disadvantageous if the solar energy system is installed above a road.

### OBJECT OF THE INVENTION

The disadvantages of the described state of the art have led to the task of proposing a solar energy system that ensures the protection of the solar panels in adverse weather conditions (wind, snow, hail, sand, dust, ice, etc.) without the need for a housing.

### DESCRIPTION

The solution to the set task is achieved in a solar energy system by means of the features listed in the characterizing section of patent claim 1. Further training and/or advantageous design variants are the subject of the dependent patent claims.

The invention is characterized by the fact that the outermost and innermost solar panels are pressed against each other by a mechanical force in the protective position, thus forming a stable package of solar panels that enables the solar panels to protect themselves from the weather. The compression force generated and the VVVV shape of the folding roof assembly of solar panels means that the solar panel package is extremely stable against weather influences and the resulting forces. The risk of individual panels swinging open or even being torn off is reliably avoided because the package offers a small contact surface and cannot be pulled apart unintentionally by the weather. Because the solar energy system is free of an enclosure, the solar energy system can have solar panels over its entire length and there is no enclosure surface that casts shadows. This results in an efficiency increase of 10 to 15%. Production costs can also be reduced by eliminating the need for a housing.

In a particularly preferred embodiment of the invention, the mechanical force in the protective position is realized by a pulling element pulling on the outermost panel and a compressive force, for example from an elastic buffer element, in particular a spring, acting on the innermost solar panel. The preferred pulling element can be a pulling rope, a chain, or a self-propelled drive. This solution is particularly simple and therefore reliable. This solution also allows for the automatic realignment of solar panels that are tilted at an angle.

It has proven useful to have a first hinge on each solar panel and an upper beam with a second hinge, which hinges connect neighboring solar panels in an articulated manner, wherein the upper beam holds the solar panels on the at least one holding element. This gives the arrangement a VVVV shape, allowing the solar panels to be moved between the protective position and the operating position in the manner of blinds, wherein adjacent solar panels rotate relative to each other.

In the protective position, the pulling rope is attached to the outermost upper beam and the compression force is attached to the innermost upper beam. This means that the pulling rope, which is necessary for retraction into the protected position anyway, can be used to compress the solar panels. The solar package is particularly stable due to the force being applied on both sides.

The invention is also characterized by the fact that a roof panel is arranged on each of the upper beams, wherein adjacent roof panels touch each other in the protective position and thereby form a protective roof. The protective roof protects the panel package in the protection position from vertical weather impacts without creating any disruptive shadows in the operating position. Even better vertical weather protection is obtained when adjacent roof panels not only touch but overlap.

The roof panels are designed as sacrificial elements. In the event of very severe mechanical damage, for example due to hail, it is permissible to deliberately destroy the roof panels in order to protect the other elements of the solar energy system. The destroyed roof panels are easily accessible and can be replaced with new roof panels with little effort.

In a further embodiment, the roof panels and/or the solar panels are heatable. This means that there is no snow load on the solar energy system, since the roof panels permanently have a temperature of 3° C. to 6° C. and the snow falling on the roof panels is immediately melted. As an alternative to a heatable roof panel, the snow can also be melted by passing an electric current through the solar panels, which heat up due to the electrical resistance that is created.

It is advisable to mount at least one holding element on two opposing masts that are bent outwards in the longitudinal direction. This means that the usable area of the solar panels in the operating position can be larger than the floor area, which is limited by the feet of the masts.

It is preferable to have gaps between the hinges of adjacent solar panels for air to escape. This prevents air pressure from building up underneath the solar panels. Pressure waves, for example, generated by trucks, are therefore reduced by the solar panels.

In another preferred embodiment of the invention, the transition between adjacent roof panels is permeable to water. This protects the panel package from the mechanical stress of precipitation. However, the water can drain away without forming puddles, and even cleans the surface of the solar panels.

For practical reasons, a first and second protective plate are attached to the innermost and outermost solar panels on the outside. These protective plates reliably shield the panel package from wind and storms.

It is also advantageous if the package of solar panels is not covered on the sides in the protective position and is therefore permeable to wind. This means that wind forces cannot attack the entire side surface of the package from the side, but are lost in the folding roof group. The folding roof group is thus stable against winds from the side.

In another preferred embodiment of the invention, a collecting channel is arranged below the package of solar panels. If the water flowing through the package must not fall on the area below the solar energy system, it can be collected in the collecting channel and drained off centrally.

It is preferable if the change between the operating position and the protective position can be carried out by a control system that evaluates local sensor signals and/or local or national meteorological data via a network.

The control system of the solar energy system can also be used to actively regulate the heat balance in urban areas, in buildings, in building complexes, over traffic, or agricultural areas. The solar folding roof cools the room by (a) shading the room during the day, (b) supporting heat radiation at night by moving into the protection position, and (c) producing electricity for the operation of local air conditioning systems exactly when and where it is needed. The entire system can be optimized to meet the needs of users and/or municipalities by means of intelligent control. For example, it is possible to reduce the nocturnal radiation from a certain temperature or time by extending the solar folding roof.

Another aspect of the invention concerns the use of the solar energy system to span traffic areas for moving or stationary traffic. Solar energy systems are ideal for traffic areas, as these require large areas of land anyway and the land has already been built on. In addition, the solar energy system with its self-protected solar panel package is particularly safe and reliably prevents parts from falling onto road users. The solar energy system or the solar folding roof can span large distances (over 30-50 meters) without supports. This means that, for example, center supports can be dispensed with on highways. The solar panels are suspended at a high level and the panels allow light to shine through from above. For these two reasons, and thanks to the fact that the folding roof retracts at dusk, there is no need for additional lighting of the roadway. Pressure waves generated by trucks are reliably dissipated as described above and cannot cause any damage to the solar energy system. Using solar energy systems to span traffic areas for moving traffic has the added benefit of noise protection. When extended, the solar energy system or solar folding roof inhibits the upward propagation of noise. This is a particular advantage for transportation routes in hilly or mountainous terrain.

The solar energy systems can be aligned lengthwise, crosswise, or parallel to the flow of traffic. Accordingly, the width of a road or the course of a road can be optimally utilized by the orientation of the solar energy system.

Further advantages and features will become apparent from the following description of several exemplary embodiments of the invention with reference to the schematic diagrams. The following are shown in a non-scale representation:

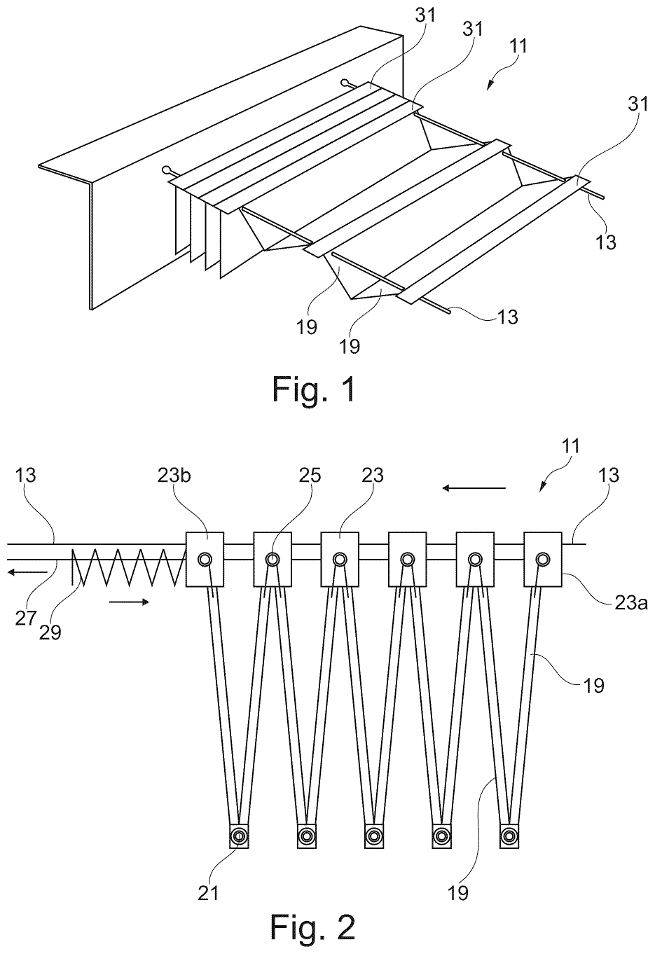

FIG. 1: an axonometric view of a solar energy system in which solar panels can be moved between a protected position and an operating position;

FIG. 2: a side view of the solar energy system in the protected position;

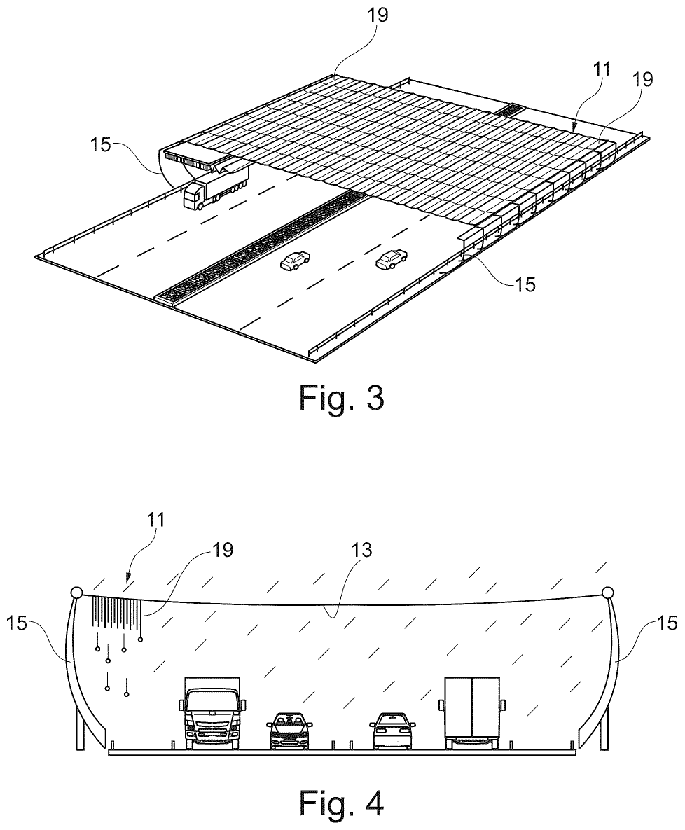

FIG. 3: an axonometric view of the solar energy system, in an embodiment in which the solar energy system extends across a multi-lane roadway;

FIG. 4: a side view of the solar energy system from FIG. 4;

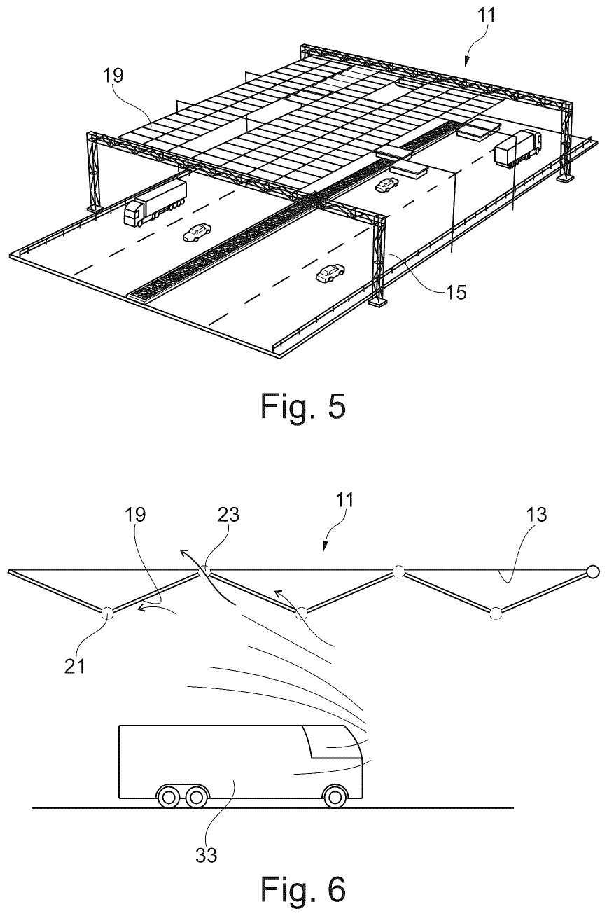

FIG. 5: an axonometric view of the solar energy system, in an embodiment in which the solar energy system extends along a multi-lane roadway and

FIG. 6: a side view of the solar energy system from FIG. 5.

The figures show an inventive solar energy system, which is designated as a whole by the reference number 11. Two essentially parallel guide ropes or guide rods 13 are provided as holding elements. The guide ropes or rods 13 are tensioned or guided between two masts 15. It would also be conceivable to fix the guide rods 13 to a flat surface, for example a roof or a wall, without using masts 15.

A plurality of solar panels 19 arranged one behind the other are held on the guide ropes or guide rods 13. When this application refers to a solar panel 19, it preferably means a plate with two essentially parallel flat sides, wherein a plurality of photovoltaic cells are arranged on at least one flat side. FIGS. 1, 2, and 6 show that adjacent solar panels 19 are connected together at their side edges in an articulated manner. The articulated connection can, for example, be designed as a first hinge 21 and as an upper beam 23 with a second hinge 25. The upper beams 23 hold the solar panels 19 in a sliding manner on the holding elements 13. The solar panels 19 are connected to each other in an articulated manner, in such a way that they can be pushed together and apart in a fan-like manner. Accordingly, the entirety of solar panels 19 can be moved from an extended operating position to a retracted protective position and vice versa, or to an intermediate position (FIG. 1).

In the operating position, the solar panels 19 form an angle with the vertical, which is preferably greater than 75 degrees. In the retracted protective position, the solar panels 19 are pulled or pushed as close together as possible by a mechanical force. The solar panels can form a stable package. This means that the solar panels provide their own protection against weather conditions such as storms, heavy rain, or hail. Storm offers the package only a small contact surface and the package offers precipitation no horizontal surfaces that could be damaged. This means that an expensive enclosure that takes up a lot of space to protect the solar panels is not needed.

The preferred method of tensioning solar panels is to use a pulling rope and spring combination, as shown in FIG. 2. A pulling rope 27, which is preferably attached to the outermost upper beam 23, pulls the solar panels 19 into the protective position to form a compressed panel package. An elastically compressible buffer element in the form of a spring 29 or a rubber block acts on the innermost upper beam. This presses the panels together until all the upper beams 23 are touching.

Roof panels 31 are arranged on the upper beams 23. In the protective position, in which the solar panels 19 form the stable package, the roof panels 31 touch or overlap. The overlapping roof panels 31 can be used to form a closed protective roof. The transitions and overlaps are preferably water-permeable so that water can run off over the solar panels. This prevents the accumulation of water and at the same time the solar panels are washed. The water from the solar panels in the protected position can be collected in a collecting channel and drained off centrally. The roof panels 31 can be designed as sacrificial elements. It is intended that hail, for example, can only destroy the roof panels. The destroyed roof panels 31 can be replaced separately with little effort.

The solar panels 19 can also be heated to ensure that no snow remains on them. It is also conceivable that an electric current is applied to the solar panels and that the solar panels 19 act as an electrical resistor. This can also cause the snow to melt and not remain on the solar panels 19. The electricity required for this can be generated by the solar energy system itself.

The lower and upper beams 21, 23 are permeable to air. Air can therefore escape between adjacent hinges. Pressure waves, which are generated, for example, by road traffic, in particular trucks 33, located below the solar energy system, can therefore be effectively reduced (FIG. 6). The solar panels 19 are therefore protected against sudden pressure loads.

A first and second protective plate can be attached to the innermost and outermost solar panels 19. This protects the package of solar panels from horizontal weather conditions. The solar package is open at the sides, which means that the wind has no contact surface. The solar package is open at the bottom, allowing water to drain away freely and be collected in the collecting channel, for example.

The masts 15 can be curved (FIGS. 3 and 4). This means that the area covered by the solar panels 19 in the operating position can be larger than the footprint of the masts 15.

An ideal application for the solar energy system is in traffic areas, where the floor space is obstructed anyway. Strong pressure waves, especially those generated by trucks 33, cannot damage the solar energy system, as explained above. The solar panels 19 can extend across or along the roadway.

### LEGEND

11 Solar energy system
13 Holding element, guide ropes, rods
15 Masts
19 Solar panel
21 First hinge
23, 23a, 23b Top beam, outermost top beam, innermost top beam
25 Second hinge
27 Pulling element, pulling rope
29 Spring
31 Roof panel
33 Truck

1.-16. (canceled)

17. Solar energy system comprising:
a plurality of solar panels arranged in a row, wherein there is an innermost and an outermost solar panel, and
at least one holding element oriented in the longitudinal direction of the so-lar energy system, on which the solar panels are held one behind the other and along which the solar panels are displaceable by an engagement means from an extended operating position into a retracted protective position and vice versa, wherein adjacent solar panels are connected to one another in an articulated manner, such that a pushing or pulling force of a solar panel is transmissible to an adjacent solar panel, wherein
the outermost and the innermost solar panels are pressed against one another in the protective position by a mechanical force, thereby forming a stable package of solar panels which enables the solar panels to protect themselves from the effects of the weather.

18. The solar energy system according to claim 17, wherein the mechanical force in the protective position is realized by a pulling element pulling on the outermost panel and a compression force, for example by means of an elastic buffer element, in particular a spring, acting on the innermost solar panel.

19. The solar energy system according to claim 17, wherein a first hinge and an upper beam with a second hinge are arranged on each solar panel, which hinges connect adjacent solar panels to one another in an articulated manner, wherein the upper beam holds the solar panels on the at least one holding element.

20. The solar energy system according to claim 17, wherein, in the protective position, the pulling rope engages on the outermost upper beam and in that the compression force engages on the innermost upper beam.

21. The solar energy system according to claim 19, wherein a roof panel is arranged on each of the upper beams, wherein adjacent roof panels touch each other in the protective position and thereby form a protective roof.

22. The solar energy system according to claim 21, wherein the roof panels are designed as sacrificial elements.

23. The solar energy system according to claim 21, wherein the roof panels and/or the solar panels are heatable.

24. The solar energy system according to claim 17, wherein the at least one holding element is held on two masts which are located opposite one another and are bent outwards in the longitudinal direction.

25. The solar energy system according to claim 19, wherein gaps are present between the hinges of adjacent solar panels, through which gaps air can escape.

26. The solar energy system according to claim 21, wherein the transition between adjacent roof panels is permeable to water.

27. The solar energy system according to claim 17, wherein a first and a second protective plate, respectively, are attached to the outermost solar panels on the outside at the innermost and outermost sides.

28. The solar energy system according to claim 17, wherein the package of solar panels is laterally uncovered and accordingly permeable to wind in the protective position.

29. The solar energy system according to claim 17, wherein a collecting channel is arranged below the package of solar panels.

30. The use of the solar energy system according to claim 17, for spanning traffic areas for moving or stationary traffic.

31. The use of the solar energy system in accordance with claim 30, wherein the solar energy system is oriented with its longitudinal direction in the transverse direction to the traffic flow.

32. The use of the solar energy system in accordance with claim 30, wherein the solar energy system is oriented with its longitudinal direction parallel to the flow of traffic.
